(19) United States
(12) Patent Application Publication
(10) Pub. No.: US 2006/0046081 A1
(43) Pub. Date: Mar. 2, 2006

(54) Laminated wear-resistant assemblies

(76) Inventor: Edward Williams, St. Louis, MO (US)

Correspondence Address: STORM L.L.P., BANK OF AMERICA PLAZA, 901 MAIN STREET, SUITE 7100, DALLAS, TX, 75202, US

(21) Appl. No.: 11/213,073

(22) Filed: Aug. 26, 2005

Related U.S. Application Data
(60) Provisional application No. 60/604,560, filed on Aug. 26, 2004.

(51) Int. Cl. B32B 15/04; B32B 9/00

(52) U.S. Cl. 428/457; 428/698; 156/160; 29/446

(57) ABSTRACT

Wear-resistant and abrasion-resistant assemblies can be affixed to surfaces of various pieces of equipment to extend the life of the equipment and increase its effectiveness. The assembly is a multi-layer composition of two harder materials that provide wear-resistance surrounding a material that provides strength and flexibility, as well as providing a means of attaching the assembly to the piece of equipment. When one or more assemblies does incur wear, assemblies can be replaced easily to further extend the life of the equipment.

### CROSS-REFERENCE TO RELATED APPICATIONS

This application claims priority to U.S. Provisional Patent Application No. 60/604,560 entitled “LAMINATED WEAR-RESISTANT ASSEMBLIES,” filed on Aug. 26, 2004 on behalf of Edward Williams, which is hereby incorporated by reference for all purposes.

### TECHNICAL FIELD

The invention relates generally to wear-resistant and abrasion-resistant assemblies that can be affixed to a surface to extend the life of the equipment and increase the effectiveness of the equipment.

### BACKGROUND

The use of wear-resistant material affixed to the working surfaces of equipment that is subject to high wear or abrasion from materials being processed is well known. Various ceramics, tungsten, or tungsten-carbide are some of the more commonly used materials. While wear-resistant materials are very hard, they tend to be expensive, brittle, and difficult to work with. For these reasons, equipment is rarely made from these materials. Depending on the arrangement and material used, such materials can be sprayed on in a thin coating, or sheets or tiles of such wear-resistant material can be affixed to working surfaces of equipment made from materials such as steel, aluminum or other metallic or non-metallic substances. Such wear-resistant materials have been used to prolong the life of a variety of equipment, such as drill bits, rotating fans, centrifuge conveyors, to name a few.

For example, U.S. Pat. No. 4,003,115 to Fisher discloses a system whereby wear resistant-material is sprayed into a cavity created along the leading edge of a conveyor screw. However, in use, the amount of hardened material that can be secured to the surface of such equipment by spraying yields a thin coating of harder material on working surfaces. While this is satisfactory for some uses, many other uses require a thicker layer of wear-resistant material. For example, U.S. Pat. No. 6,648,601 also owned by the same assignee as the present invention, discloses affixing patterns of tiles of a wear-resistant material to rotating fan assemblies used for processing coal dust, which is highly abrasive, and would wear off a thin coating of hardened material in a very short time. Similarly, U.S. Pat. No. 5,380,434 to Paschedag discloses a system for affixing flat, wear-resistant tiles to the leading edge of a centrifuge conveyor screw, and U.S. Pat. No. 6,739,411, owned by the same assignee as the present application discloses affixing tiles of a wear-resistant material to the areas of drill bits that are subject to high wear.

Because such wear-resistant materials tend to be very brittle, they are prone to fractures or cracking. Thus they can be difficult to work with. Additionally, depending on the equipment on which the wear-resistant materials are being used, and the product being processed in the equipment, cracked or chipped materials could contaminate the product, or cause damage in the equipment.

One solution has been to affix them to a carrier, or backing, made of a material that is easier to work with, such as steel. However, there can be difficulties with securing the wear-resistant materials to the carrier, just as there are difficulties in securing the wear-resistant materials directly to the equipment. Because the wear-resistant materials are prone to fracturing or breaking, drilling holes through the materials to secure them to a carrier or other surface with fastening devices can be difficult, and result in a high incident of fracturing, cracking or chipping. One solution has been to solder, or braze the wear-resistant materials to the carrier. However, depending on the material characteristics of the carrier and the wear-resistant materials, it is necessary to heat the materials to a high temperature to perform the soldering or brazing. Because the materials expand and contract at different rates, after being secured, they contract at different rates. If the differences are great enough, the carrier will torque or shear as it cools, and the attached wear-resistant material can also bend, or will crack or fracture, or in some situations, the secure itself will fail and the two materials will detach from each other.

Therefore, what is needed is a system and method for affixing wear-resistant members to equipment that is simple, cost-effective and easy to use. Such systems should provide for a method of securely fastening wear-resistant members to equipment, as wear-resistant materials are typically hard and can be brittle and break easily under certain circumstances. Such systems and methods should, among other things, reduce or eliminate instances of fracturing or cracking of the wear-resistant materials. Such systems should also reduce the possibility of the attached wear-resistant members becoming detached and contaminating product or damaging equipment.

### SUMMARY

The present invention, accordingly, provides a multi-layer laminated wear-resistant assembly. The assembly comprises a bracket, typically made of steel or some similar material, which can be welded, soldered or glued and can be machined or manipulated. The bracket is layered between a plate wear-resistant material, such as tungsten-carbide on the front, and a third layer at the rear of the bracket, which can be made of the same material as the front layer, or of a different material having similar characteristics of expansion and contraction as the plate of wear-resistant material. The layers of the assembly are secured together by soldering, brazing or some other method.

Because the bracket material is trapped between two layers of harder materials with similar characteristics, it does not warp or shear when the materials begin to cool after brazing, but stays “stretched” between the two layers of harder materials. This “stretched” state is due to the shrinkage differentials of the materials used in the layers of the assembly that occur after brazing when the assembly is cooling. When the entire laminated assembly has cooled, a stronger mechanism is achieved that is more resistant to cracking or fracturing because of the more flexible material that comprises the middle layer of the assembly providing a support structure.

By creating a laminate of a bracket made of a more flexible material, such as steel or other material, with wear-resistant material as the top layer of the laminate, and a third layer of material on the rear side of the steel, a much stronger, more useful product is achieved than would be if only one of the materials was used alone. The face of hardened material prolongs the life of the equipment and increases the effective time of operation before repair or replacement is necessary. Additionally, the individual assemblies can be easily removed and replaced as assemblies wear over time, further increasing the life of the mechanism.

In one preferred embodiment of the present invention, a laminated wear assembly is provided. A core member having a first and an opposite second face and having an attaching member extending substantially perpendicular from the second face to substantially form an “L” shape is included in the laminated wear assembly. Moreover, the core member further comprises a first coefficient of thermal expansion. Additionally, a first wear member is also included having a second coefficient of thermal expansion secured to a substantial portion of the first face, wherein the first coefficient of thermal expansion is greater than the second coefficient of thermal expansion. In addition to having a first wear member, there is also a second wear member having a third coefficient of thermal expansion secured to a substantial portion of the second face, wherein the second coefficient of thermal expansion is approximately equal the third coefficient of thermal expansion. The laminated wear assembly, too, is formed such that the core member remains substantially stretched at approximately room temperature.

In another preferred embodiment of the present invention, the core member comprises a material selected from the group consisting of stainless steel, carbon steel, aluminum, and NiCroMoly.

In yet another preferred embodiment of the present invention, the first wear member and/or the second wear member are made from a composition comprising at least tungsten-carbide.

In another preferred embodiment of the present invention, the core member, the first wear member, and the second wear member are secured to one another by brazing, soldering, welding, or gluing.

In an alternative embodiment of the present invention, a method of forming a laminated wear assembly is provided. A core member is formed having a first and a second opposing face with an attaching member extending substantially perpendicular from the second face to form an “L” shape, and having a first coefficient of thermal expansion. A first wear member is also formed having a second coefficient of thermal expansion, wherein the second coefficient of thermal expansion is less than the first coefficient of thermal expansion. Additionally, a second wear member is formed having a third coefficient of thermal expansion, wherein the second coefficient of thermal expansion is approximately equal to the third coefficient of thermal expansion. Onced formed, the core member, the first wear member, and the second wear member are heated to a sufficient temperature that causes the core member, the first wear member, and the second wear member to secure with one another and to form the laminated wear assembly. After heating, the laminated wear assembly is cooled to approximately room temperature so that the core member remains in tension in a tensile state of stress at approximately room temperature.

Another alternative embodiment of the present invention provides a method of forming a laminated assembly. With this alternative embodiment, a core member, having a first and a second opposing face, a first wear member, and a second wear member are formed. Once formed, each of the core member, the first wear member, and the second wear member are elongated. Once elongated, the first wear member is secured to the first face, and the second wear member is secured to the second opposing face. The first wear member and the second wear member are then reduced, while the elongation of the core member is maintained.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an exploded side view of an assembly embodying features of the present invention;

FIG. 2 is a rear perspective view of an assembly of the present invention;

FIG. 3 is a rear exploded view of an assembly embodying the features of the present invention;

FIG. 4 is a front view showing several assemblies secured to the leading edge of a piece of equipment; and

FIG. 5 is a side view of a secured assembly of FIG. 4.

### DETAILED DESCRIPTION

In the discussion of the FIGURES, the same reference numerals will be used throughout to refer to the same or similar components. In the following discussion, numerous specific details are set forth to provide a thorough understanding of the present invention. However, it will be apparent to those skilled in the art that the present invention may be practiced without such specific details.

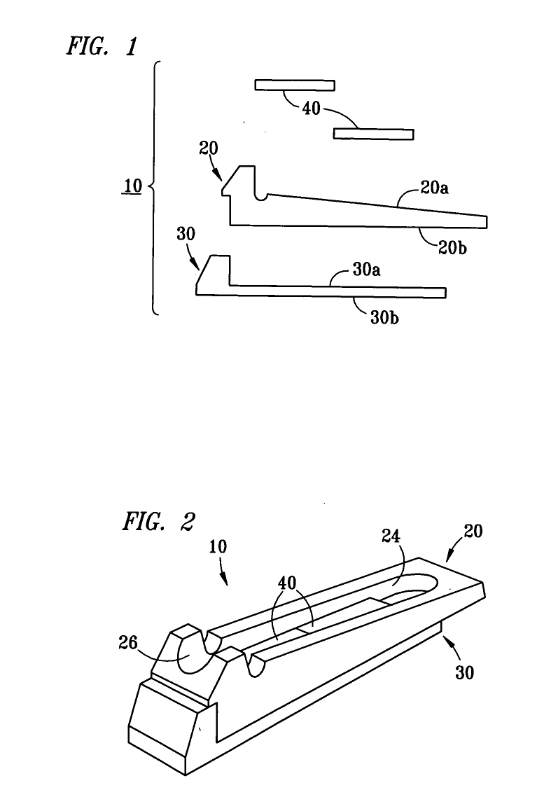

Referring to FIGS. 1-3 of the drawings, the reference numeral 10 generally designates a laminated assembly of the present invention. The assembly 10 comprises a first wear member 30, a core member 20, and a second wear member or backing element 40.

The assembly 10 is essentially a bracket that can be affixed to machinery to protect wear surfaces. For example, assembly 10 can be affixed to driving faces of an extrusion screw, as shown in FIG. 4. The assembly 10 is formed by sandwiching the core member 20 made of a workable material, such as steel, between the first wear member 30 and the second wear member 40, where the core member 20, the first wear member 30 and the second wear member 40 are secured to one another, such as by brazing, gluing, soldering, or welding. Typically, the first wear member 30 and the second wear member 40 are comprised of a hard material, such as tungsten-carbide.

Specifically, each of the core member 20 and the first wear member 30 have first faces 20b and 30b and second faces 20a and 30a, respectively. In forming the assembly 10, the second face 30a of the first wear member 30 is secured to the first face 20b of the core member 20, and the second wear member 40 is secured to the second face 20a of the core member 20 in slot 24. However, as it can be seen in FIGS. 1-3, second wear member 40 does not completely cover the second face 20a of the core member 20. There is an attaching member 22 extending substantially perpendicular from the second face 20b of the core member 20 such that the core member 20 forms an “L” shape. The attaching member 26 would thus allow for a portion of the workable material, such as steel, to be exposed so as to attach to machinery, as shown in FIG. 4, while the first face 30b of the first wear member 30 faces outward and comes in contact with the admixture being processed.

In the process of securing the layers of the assembly together, heating is commonly employed; moreover, it is not uncommon to utilize assembly 10 in heated environments. One of the reasons for employing the multiple layers of wear members is due to differing coefficients of thermal expansion of the dissimilar metals. Typically, the hard protective metals, such as tungsten-carbide, have a lower coefficient of thermal expansion than the more workable core materials, such as steel. The relative differential expansions/contractions usually cause bending or bowing, resulting in torsion, compression, and tension that can cause failure. Thus, as stated above, the second wear member 40 does not cover the entire second face 20a of the core member 20; it covers enough area of the second face 20a of the core member 20 to prevent the core member 20 from bending or bowing as the assembly 10 is heated or cools. Reduction in the relative size of the second wear member 40 can reduce costs because less material can be used to cover the rear side of the assembly 10.

Additionally, if the assembly 10 is to be secured to the underlying equipment by means of soldering or welding, in many cases, it is easier to weld the exposed material of the core member 20 on the rear side of the assembly 10 to the underlying equipment or machinery than having to weld the types of harder materials that typically comprise the second wear member 40 to standard equipment or machinery. In some cases, depending on the harder materials used, welding of those materials may not even be possible.

Furthermore, as stated above, the layers of the assembly 10 are typically laminated together by soldering, brazing or other means that utilize heat. After they have been heated during one of these processes (or heated independently of the joining process), the dissimilar metals are secured together. As the assembly cools, the core layer 30 remains in an expanded or “stretched” state between the two outer layers 30 and 40. In other words, once at room temperature, the core member 20 is in tension or in a tensile stress state in its major direction. Thus, additional, intentional residual stresses are added to any inherent residual stresses present in the assembly 10. As an example, consider that core member 20 and second face 30a are 1.5 inches in the major (longest) direction before heating, while second wear member 40 is 0.925 inches before heating. After lamination and cooling to ambient temperature, second face 30a and the second wear member 40 return to 1.5 inches and 0.925 inches, respectively, but the core member 30 remains partially extended. Therefore, the assembly 10 has a dominant or major tensile stress, resulting from differential expansion (contraction) along the major dimension of the assembly 10.

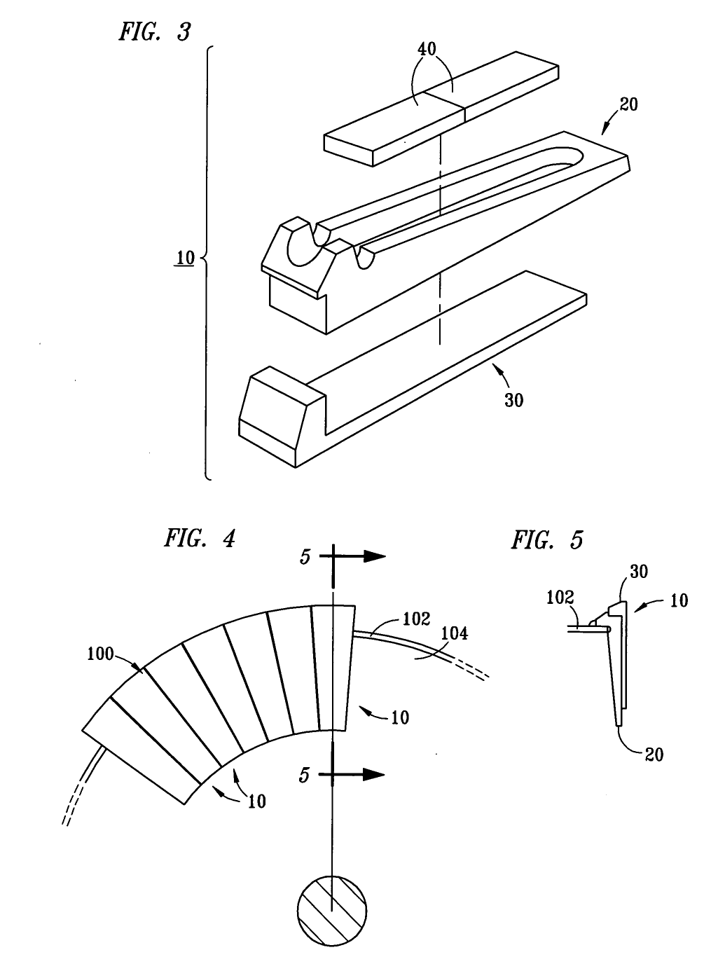

Moreover, it is also possible to form each of the first wear member 30 and the second wear member 40 of multiple pieces. Depending on the conditions and circumstances of the particular application for the assembly 10, flexibility may be desirable, which would be provided by replacing a single piece of hard material with multiple pieces of material. Specifically, as can be seen in FIG. 3, the second wear member 40 is formed of two pieces. However, any number of pieces can be utilized.

Additionally, the core member 20 may also have a variety of configurations. As shown in FIGS. 1-3, a portion of the second face 20a of the core member 20 is exposed. This type of configuration allows for additional welds to underlying machinery. However, it is also possible to completely cover both the first face 20b and the second face 20a of the core member 20.

As seen in FIGS. 4 and 5, in operation, the core member 20 hangs over and is secured to the outer edge 102 of the equipment 100, such as an extrusion screw, by means of spot welding of the attachment member 26 of the core member 20 to the outer edge 102 of the equipment 100. Additionally, the bottom of the assembly 10 is spot-welded to the leading edge 104 of the equipment 100. With this configuration, the core member 20, is made of a material such as steel, which can be welded to the extrusion screw 100. However, it can be appreciated that the assembly 10 can be secured to the equipment 100 by a variety of methods, including gluing, brazing, soldering or other securing methods. Another benefit of the present invention is that when an assembly 10 does wear and need replacing, this can be done easily in the field by soldering, welding or gluing a new assembly 10 to the equipment 100. Because wear-resistant materials such as tungsten-carbide can be brazed, but cannot be welded, replacing surfacing material made only of tungsten-carbide in situ would be difficult, as brazing in typical ambient environments is difficult and does not always produce a strong bond.

The front face 30b of the first wear member 30 faces outward from the equipment 100 and comes in contact with the material being processed in the equipment 100. As can be seen, a series of assemblies 10 are placed adjacent to each other and to provide a smooth continuous covering along the leading edge 104 of the extrusion screw 100. As can be understood, the size and shape of assemblies used can vary in accordance with the size and shape of the equipment 100.

Thus, the arrangement of the present invention yields an assembly 10 of greater strength and resistance to cracking than use of a single layer of tungsten-carbide, and achieves rigidity from having a layer of more flexible material between two layers of harder material.

It is understood that the present invention can take many forms and embodiments. Accordingly, several variations may be made in the foregoing without departing from the spirit or the scope of the invention. Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A laminated wear assembly, comprising:
a core member having a first and an opposite second face, and having an attaching member extending substantially perpendicular from said second face to substantially form an “L” shape, and having a first coefficient of thermal expansion;
a first wear member having a second coefficient of thermal expansion secured to a substantial portion of said first face, wherein said first coefficient of thermal expansion is greater than said second coefficient of thermal expansion;
a second wear member having a third coefficient of thermal expansion secured to a substantial portion of said second face, wherein said second coefficient of thermal expansion is approximately equal said third coefficient of thermal expansion; and
wherein said laminated wear assembly is formed such that said core member remains substantially stretched at approximately room temperature.

2. The laminated wear assembly of claim 1, wherein said core member comprises a material selected from the group consisting of stainless steel, carbon steel, aluminum, and NiCroMoly.

3. The laminated wear assembly of claim 1, wherein said first wear member is made from a composition comprising at least tungsten-carbide.

4. The laminated wear assembly of claim 1, wherein said second wear member is made from a composition comprising at least tungsten-carbide.

5. The laminated wear assembly of claim 1, wherein the laminated wear assembly further comprising having said core member, said first wear member, and said second wear member secured to one another by brazing, soldering, welding, or gluing.

6. A method of forming a laminated wear assembly, comprising:
forming a core member having a first and a second opposing face with an attaching member extending substantially perpendicular from said second face to form an “L” shape, and having a first coefficient of thermal expansion;
forming a first wear member having a second coefficient of thermal expansion, wherein said second coefficient of thermal expansion is less than said first coefficient of thermal expansion;
forming a second wear member having a third coefficient of thermal expansion, wherein said second coefficient of thermal expansion is approximately equal to said third coefficient of thermal expansion;
heating said core member, said first wear member, and said second wear member to a sufficient temperature that causes said core member, said first wear member, and said second wear member to secure with one another and to form said laminated wear assembly; and
cooling said laminated wear assembly to approximately room temperature so that said core member remains in tension in a tensile state of stress at approximately room temperature.

7. The method of claim 6, wherein the step of securing further comprises brazing, soldering, welding, or gluing.

8. The method of claim 6, wherein said core member comprises a material selected from the group consisting of stainless steel, carbon steel, aluminum, and NiCroMoly.

9. The method of claim 6, wherein said first wear member is made from a composition comprising at least tungsten-carbide.

10. The method of claim 6, wherein said second wear member is made from a composition comprising at least tungsten-carbide.

11. A method of forming a laminated assembly, comprising:
forming a core member having a first a first and a second opposing face;
forming a first wear member;
forming a second wear member;
elongating said core member, said first wear member, and said second wear member;
once elongated, securing said first wear member to said first face and securing said second wear member to said second opposing face;
reducing said first wear member and said second wear member; and
maintaining elongation of said core member.

12. The method of claim 11, wherein the step of securing further comprises brazing, soldering, welding, or gluing.

13. The method of claim 11, wherein said core member comprises a material selected from the group consisting of stainless steel, carbon steel, aluminum, and NiCroMoly.

14. The method of claim 11, wherein said first wear member is made from a composition comprising at least tungsten-carbide.

15. The method of claim 1, wherein said second wear member is made from a composition comprising at least tungsten-carbide.
